(19) United States
(12) Patent Application Publication
(10) Pub. No.: US 2006/0103047 A1
(43) Pub. Date: May 18, 2006

(54) Vehicular division bar assembly free of structural metal

(75) Inventor: David T. Zwolinski, Maryville, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 10/990,040

(22) Filed: Nov. 16, 2004

(51) Int. Cl. B32B 33/00; E06B 7/16

(52) U.S. Cl. 264/174.11; 49/502; 49/441; 49/490.1; 264/173.17

(57) ABSTRACT

A method of forming a division bar assembly having a pocket for receiving a fixed pane, the pocket defined by a pocket closed end and a pair of projecting pocket legs, and a channel for slidably receiving a movable pane, the channel defined by the pocket closed end and a pair of channel legs, wherein at least one of the channel legs is connected to a pocket leg at a transition intermediate the pocket closed end and a free end of the pocket leg, with the at least one channel leg initially diverging from the remaining channel leg. The diverging channel leg is urged toward the remaining channel leg in a downstream post-forming step.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to vehicular weatherseals, and more particularly, to a division bar assembly being free of structural metal, formed of relatively lightweight recyclable and colorable materials, and a method for manufacturing such a division bar assembly.

2. Description of Related Art

Many motor vehicles are constructed with a rear door having a forward window opening that carries a retractable, or movable window pane and a rearward window opening that is fitted with a fixed window pane. The fixed window pane, commonly referred to as a vent window or fixed vent, is typically required to avoid interference of the retractable window pane with the rear wheel well of the vehicle, when the movable window pane is lowered. The larger movable window pane can be completely lowered to a fully open position, while the fixed window pane remains stationary and does not detract from visibility through the windows by the driver or the passengers.

Because the movable window pane slides up and down relative to the adjacent fixed window pane, the molding or trim surrounding the fixed window pane must include a track or channel on a forward edge for slidable engagement with the movable window pane. A portion of the channel extends inwardly and outwardly of the vehicle to overlap an inner and outer surface of both the movable and the fixed window.

Such interconnection requires relatively complicated weatherseals encompassing a number of channels, fasteners and seals as well as secondary clips or fasteners to engage the weatherseal with the vehicle. The weatherseal also includes a metal reinforcement to provide structural integrity of the weatherseal. These numerous components increase the weight of the weatherseal as well as the associated labor required to install the individual components. In addition, a large number of components represents a source for construction flaws in manufacture as well as installation.

Therefore, the need exists for a weatherseal that can perform the required sealing functions, while reducing overall weight of the weatherseal. The further need exists for a weatherseal that can readily be recycled without excessive cost at the end of the useful life of the vehicle. The need also exists for a weatherseal that can guide a panel, such as a window, along a complex curve, while maintaining a sealed relation with a fixed pane. A need exists for a weatherseal that can provide the necessary rigidity and strength without requiring metal reinforcement.

### BRIEF SUMMARY OF THE INVENTION

The present invention provides a weatherseal that can guide a movable pane along a complex curve relative to a sealed fixed pane, wherein the weatherseal can be formed without traditional metal reinforcements.

In one configuration, the weatherseal is a division bar assembly for receiving a fixed pane and a moveable pane, wherein the division bar assembly includes (i) a U-shape pocket for receiving a peripheral portion of the fixed pane, the pocket defined by a pocket closed end and a pair of pocket legs; and
(ii) a channel for receiving the moveable pane, the channel at least partially defined by the pocket closed end and a pair of channel legs, at least one of the channel legs connected to one of the pocket legs at a position spaced from the pocket closed end.

In further constructions, each channel leg can be connected to a corresponding one of the pocket legs to dispose the pocket closed end intermediate the channel legs.

The division bar assembly can be manufactured as an extruded profile in a splayed or open configuration, wherein the profile is post-formed or shaped downstream of the extrusion to a closed position. As the division bar assembly is selected to allow transformation from the splayed configuration to the closed configuration, sealing lips can be readily formed with the assembly in the open configuration. The post-forming can be in-line with the forming step, or a subsequent process following a reheating of the formed body. It is further contemplated the assembly can be subsequently heated, in an off line step, to allow sections of the assembly to follow a complex curve.

### BRIEF DESCRIPTION OF THE SEVERAL VIEWS OF THE DRAWING(S)

FIG. 1 is a perspective view of the vehicle incorporating the present division bar assembly.

FIG. 2 is a cross-sectional view taken along lines 2-2 of FIG. 1, showing a movable pane in phantom.

FIG. 3 is the cross-sectional view of the division bar assembly of FIG. 2, with the movable pane in a retracted position.

FIG. 4 is a cross-sectional view showing the division bar assembly in a formed (extruded), yet open configuration.

FIG. 5 is a cross-sectional view of the division bar assembly of FIG. 4 after a post-forming step downstream of the forming step (extrusion).

FIG. 6 is a cross-sectional view showing an alternative configuration of the division bar assembly in a formed (extruded), yet open configuration.

FIG. 7 is a cross-sectional view of the division bar assembly of FIG. 6 after a post-forming step downstream of the forming step (extrusion).

FIG. 8 is a cross-sectional view showing a further configuration of the division bar assembly in a formed (extruded), yet open configuration.

FIG. 9 is a cross-sectional view of the division bar assembly of FIG. 8 after a post-forming step downstream of the forming step (extrusion).

FIG. 10 is a cross-sectional view of another configuration of the division bar assembly in formed (extruded), yet open configuration.

FIG. 11 is a cross-sectional view of the division bar assembly of FIG. 10 after a post-forming step downstream of the forming step (extrusion).

FIG. 12 is a cross-sectional view of an additional configuration of the division bar assembly in a formed (extruded), yet open configuration.

FIG. 13 is a cross-sectional view of the division bar assembly of FIG. 12 after a downstream post-forming step and operably connected to a fixed pane with a sealant intermediate of a portion of the fixed pane and the division bar assembly.

### DETAILED DESCRIPTION OF THE INVENTION

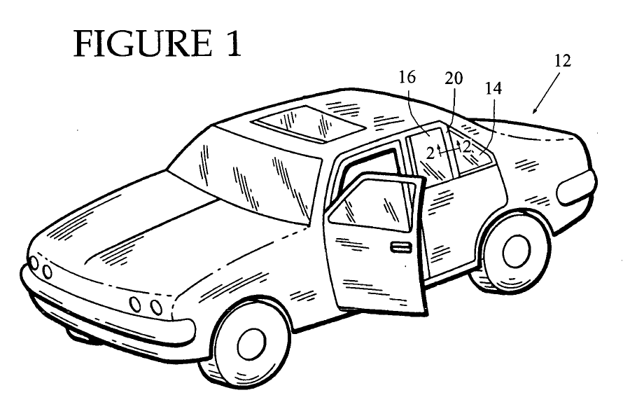

Referring to FIG. 1, a division bar assembly 20 of the present invention can be employed in an automotive vehicle 12. The division bar assembly 20 provides an interface between a fixed pane 14 and a movable pane 16. As an exemplary location, the division bar assembly 20 is shown in a rear door, operably interconnecting a portion of the fixed pane 14 and the movable pane 16. However, it is understood the division bar assembly 20 can be employed in a front door of the vehicle 12, or any other interface between the fixed pane 14 and the movable pane 16.

The fixed pane 14 and the movable pane 16 are described in terms of a transparent or translucent glass pane, such as in a window pane. However, it is understood the panes 14, 16 can be an opaque member formed of any of a variety of materials including metals, plastics, polymers, composites and laminates, each of which is intended to be encompassed by the term pane.

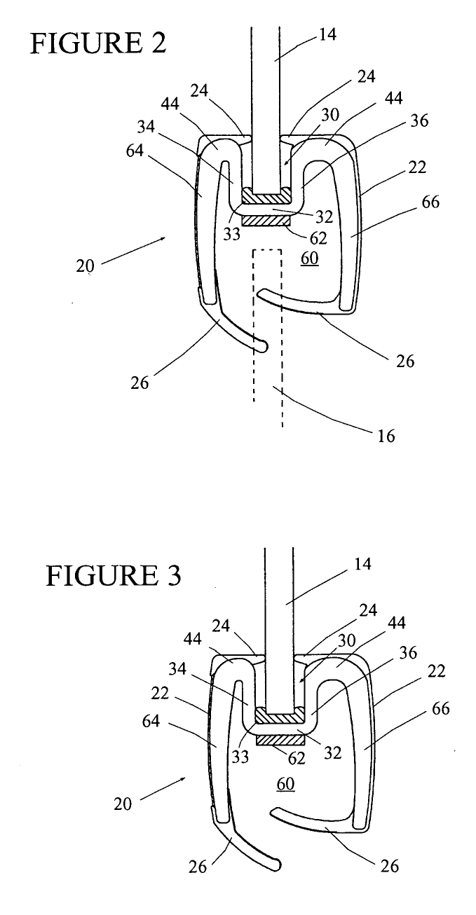

Referring to FIGS. 2-13, the division bar assembly 20 includes a pocket 30 for receiving the fixed pane 14 and a channel 60 for receiving the movable pane 16 (shown in FIG. 2). Preferably, the pocket 30 and the channel 60 are formed as an integral piece.

The division bar assembly 20 can include an overlay layer 22 on portions of the channel 60 as well as locator lips 24 projecting into the pocket 30 and sealing lips 26 projecting into the channel. It is further contemplated, the overlay layer 22, the locator lips 24 and the sealing lips 26 can be formed of the same or different materials. Further, the overlay layer 22, the locater lips 24 and the sealing lips 26 can be formed of the same or different material as the pocket 30 and the channel 60. The locator lips 24 and the sealing lips 26 can both be employed, or either the locator lips or the sealing lips can be employed. Typically, the locator lips 24 provide a static seal to the fixed pane 14, and the sealing lips 26 provide a dynamic seal to the moveable pane 16.

Therefore, the sealing lips 26 can include a friction reducing coating such as polytetrafluoroethylene (PTFE) or other compatible, and preferably recyclable material such as, but not limited to high density polyethylene (HDPE). It is also understood the locator lips 24 can include a coating, such as sprayed on polyurethane or flock to reduce squeak or itch.

The pocket 30 is defined by a pocket closed end 32 and a pair of pocket legs 34, 36 extending from the pocket closed end. The pocket 30 is sized to receive a peripheral edge of the fixed pane 14. Although not required, as seen in FIGS. 2, 3 and 13, the pocket 30 can include a mastic, adhesive or sealant 33 to enhance sealing between the fixed pane 14 and the pocket.

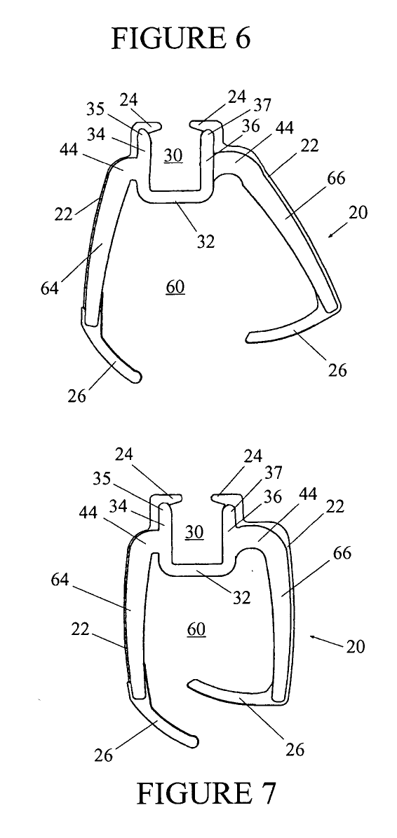

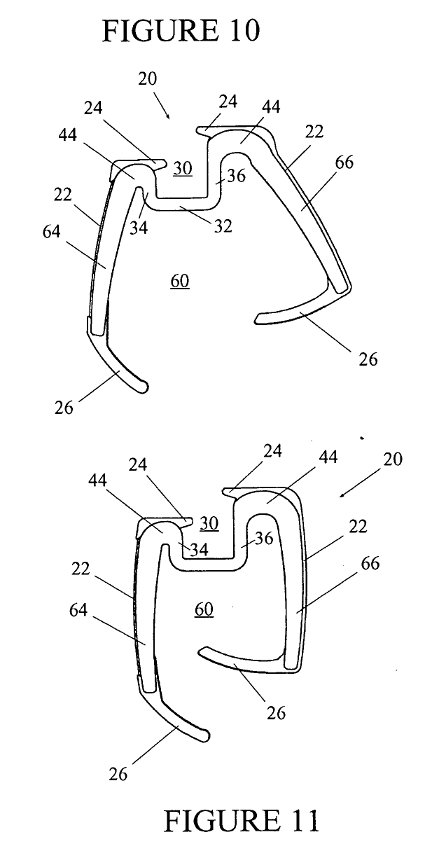

The pocket legs 34, 36 extend a given length from the pocket closed end 32. The pocket legs 34, 36 can extend to terminate at a free end 35, 37 as seen in FIGS. 6 and 7, or the pocket legs can extend to terminate at a transition 44 to a corresponding portion of the channel 60 as seen in FIGS. 2-5 and 10-11. In either construction, the pocket legs 34, 36 can be of equal or different length. Specifically, as seen in FIGS. 2-9, the pocket legs 34, 36 can extend substantially the same length. Alternatively, as seen in FIGS. 10 and 11, the pocket legs 34, 36 can be of different lengths.

The channel 60 is generally defined by the pocket closed end 32 and a pair of channel legs 64, 66, wherein at least one channel leg, such as leg 66, is connected to a pocket leg 36 at the transition 44 spaced from the pocket closed end 32. The channel 60 is sized to receive a portion of the moveable pane 16, typically in a sliding relation along a longitudinal dimension of the division bar assembly 20.

As seen in FIGS. 2-5, the channel legs 64, 66 extend from the connection to the corresponding pocket legs 34, 36 to define the transition 44. The transition 44 of the channel legs 64, 66 to the corresponding pocket leg 34, 36 can provide a bending point, allowing the channel legs to be post-formed relative to the pocket legs during the manufacturing process. Therefore, the transition 44 can be within a length of the channel legs 64, 66 or at the junction with the pocket legs 34, 36 so as to provide reorientation during the manufacturing process.

Further referring to FIGS. 2-5, the channel legs 64, 66 extend from the ends of the pocket legs 34, 36 at the transition 44. The channel legs 64, 66 extend in a generally opposite direction to the pocket legs 34, 36 and extend beyond the pocket closed end 32 by a distance sufficient to guide, or control, movement of the moveable pane 16 along the division bar assembly 20, while maintaining a sealed relation with the moveable pane.

Referring to FIGS. 6 and 7, the channel legs 64, 66 extend from the pocket legs 34, 36 at the transition 44 located intermediate the pocket closed end 32 and the free end 35, 37 of the pocket legs.

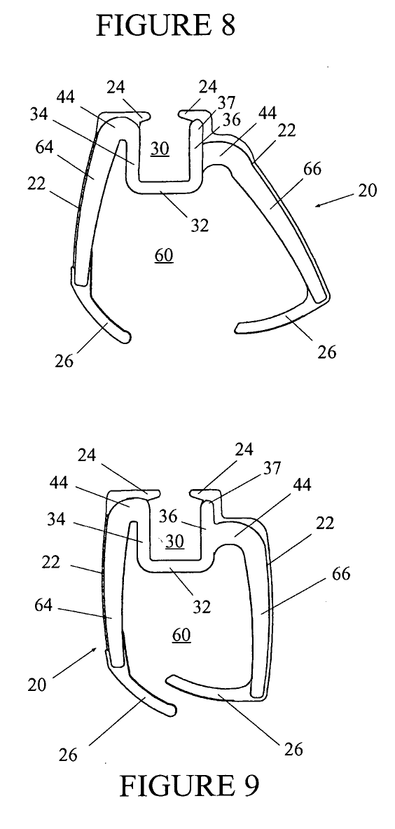

Referring to FIGS. 8 and 9, one channel leg 64 extends from the end 35 of pocket leg 34 and the remaining channel leg 66 extends from the pocket leg 36 at the transition 44 located intermediate the pocket closed end 32 and the free end 37 of the pocket leg 36.

Referring to FIGS. 10 and 11, the channel legs 64, 66 extend from the transitions 44 at the ends of the corresponding pocket legs 34, 36, wherein the pocket legs are of different lengths. Thus, the division bar assembly 20 can provide a unique inside and outside appearance.

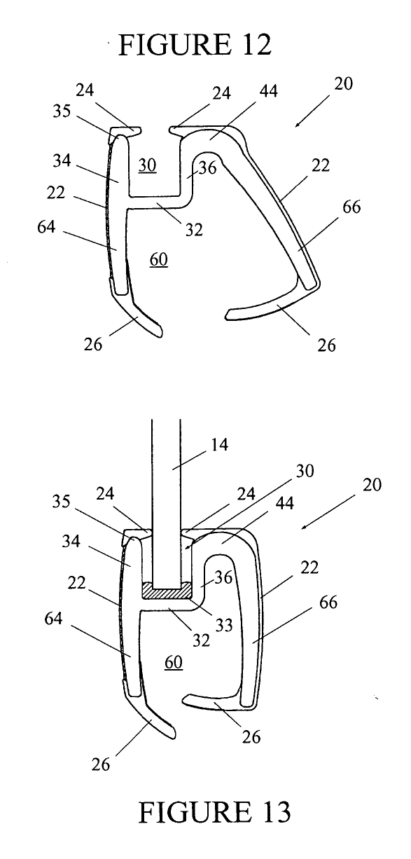

As seen in FIGS. 12 and 13, the channel leg 64 extends from the junction of the pocket closed end 32 and the pocket leg 34, and the remaining channel leg 66 extends from the pocket leg 36 at the transition 44 located intermediate the pocket closed end and the free end 37 of the leg 36. Alternatively, the channel leg 66 can project from the pocket leg 36, at the end of the pocket leg.

The pocket leg 34 and channel leg 64 are on the exterior of the vehicle. By disposing the pocket leg 34 and the channel leg 64 in substantially the same plane as specifically seen in FIGS. 12 and 13, the thickness of the division bar assembly 20 exterior to the vehicle 12 can be reduced, thereby decreasing wind resistance and associated wind noise.

Referring to FIGS. 2 and 3, it is also contemplated that a wear strip 62 can be disposed within the channel 60. The wear strip 62 is selected to provide a relatively low friction surface for releaseably engaging the moveable pane 16. The wear strip 62 can be located on the sealing lips 26 or the surface of the pocket closed end 32 defining a portion of the channel 60. Although the wear strip 62 is shown only in FIGS. 2 and 3, it is understood the wear strip can be incorporated in any configuration of the division bar assembly 20.

In one configuration, the pocket 30 and the channel 60 are formed of a recyclable thermoplastic material. The available materials can include a number of different plastic materials, for example, traditional thermoplastics as well as thermoplastic elastomers (TPEs). TPEs are sometimes categorized as thermoplastics and sometimes as elastomers. For purposes of this invention, no such distinction will be made, and plastics, thermoplastics and thermoplastic elastomers will all be referred to as thermoplastics, in that the material is capable of being heated to a molten state and solidifying when cooled.

Preferably, the materials are selected to provide sufficient structural rigidity to the division bar assembly 20, so that metal reinforcement in the form of a reinforcing member, such as rolled, formed metal is not required. Thus, the division bar assembly 20 is a self supporting construction, free of structural metal.

Thermoplastics are commercially available in several different brands and types. Each type can be obtained in different grades having different properties such as, hardness, tensile strength, compression set, elongation, thermal stability and colorability. Selection of the appropriate theremoplastic for a particular application depends on a suitable combination for such properties.

Types of thermoplastics which are particularly useful are styrenic block co-polymers, rubber polyolefin blends, elastomeric alloys, thermoplastic alloys, thermoplastic elastomeric alloys, thermoplastic isomers, thermoplastic polyurethanes, polyvinyl chlorides, thermoplastic elastomers and blends thereof.

Styrenic block copolymers are commercially available in many types (and grades within types), for example, Kraton® from Shell Chemical Co. is based on block copolymers of styrene with a diene or an olefin pair, ethylene-butylene. The diene can be isoprene or butadiene.

The rubber-polyolefin blends (or thermoplastic polyolefins (TPOs)) are blends of various polyolefins with ethylene-propylene rubber (EPR) or ethylene-propylene-diene-monomer (EPDM). Suitable polyolefins include polypropylene and various types of polyethylene. Copolymers of propylene and ethylene and blends of TPOs can also be used. TPOs are also useful as modifiers of other thermoplastics.

Alloying is an interactive combination of two or more materials to give a material having better properties than those of the corresponding blend. Thermoplastic alloys are available with properties enabling them to be painted. Thermoplastic elastomeric alloys and elastomeric alloys (EAs) are composed of synergistic mixtures of two or more polymers that have been treated to give them properties different from simple blends of the major constituents. The two types of elastomeric alloys are melt processable rubbers (MPRs) and thermoplastic vulcanizates (TPVs).

EA-MPRs are a category of thermoplastics, and particularly TPEs, made of a highly plasticized, single phase combination of a chlorinated polyolefin, an ethylene-vinyl acetate copolymer and an acrylic ester mixture in which the rubber phase is highly crosslinked, for example, Alcryn® from E. I. du Pont Nemours, Inc. EA-TPVs are made of a rubber/plastic polymer mixture in which the rubber phase is fully crosslinked.

The plastic phase of a TPV is commonly a polyolefin (especially polypropylene), and the rubber phase is often an ethylene-propylene elastomer. An example of a TPV, suitable for windows seals, is formed from polypropylene and EPDM rubber and is commercially available in several grades as Santoprene® from Monsanto Chemical Co. or Permaprene™ TPV from Metzeler Automotive Profile Systems.

Thermoplastic polyurethanes (TPUS) are formed by copolymerization of diisocyanates with long-chain diols and short-chain diols. TPUs are available commercially in a number of types and grades, for example, Texin® from Mobay Corporation, Estane® from B. F. Goodrich Co., Pellethane® from Dow Chemical Corp. and Q-Thane® from K. J. Quinn and Co., Inc.

Polyvinyl chloride (PVC) based thermoplastics and particularly PVC based TPEs are also suitable for window seals and are available in different grades and blends with other thermoplastics and rubbers. Sunprene®, a thermoplastic elastomer based on a high molecular weight PVC resin as from Mitsubishi Chemical Mkv Company has been found satisfactory.

Thermoplastic ionomers are polymers containing interchain ionic bonding which affords tough, durable, transparent thermoplastics, for example, Surlyn® from E. I. du Pont de Nemours, Inc.

A thermoplastic, for example a polypropylene, which can form the pocket 30, preferably has a hardness in the range of 30 to 85 durometer, preferably 70 durometer, Shore D. A more flexible TPE, for example Santoprene® or Permaprene™, which can form the sealing lips 26, has a hardness between 40 to 90 durometer preferably 70 durometer Shore A.

In those configurations including the overlay layer 22, or where the overlay layer is contiguous with the sealing lips 24, 26, the overlay layer can be formed from a softer more resilient thermoplastic, such as a TPE, for example Santoprene® or Permaprene™, having a hardness in the range of 40 to 90 durometer, preferably 70 durometer Shore A.

Such thermoplastics are readily processed and fabricated, for example, by extrusion or molding and are particularly amenable to coextrusion and simultaneous molding of two or more thermoplastics of different durometer values. Many thermoplastics are readily colored to match the vehicle either by incorporating pigment, applying a decorative film or by painting. Directly paintable thermoplastics have a high surface energy material blended into the base polymer to accept paints, including water based paints, without any pretreatment. Various hardnesses of this material are available from Ferro Corporation.

Some thermoplastics can be made with a high gloss finish, for example a Class A finish or a gloss of at least 60 numerical value when measured at a 60° angle with a gloss meter is readily obtained which is substantially higher than can be obtained with an EPDM rubber seal. It is desirable that the thermoplastics meet the exterior weathering cycle per SAE J1960 with minimum change in color or gloss.

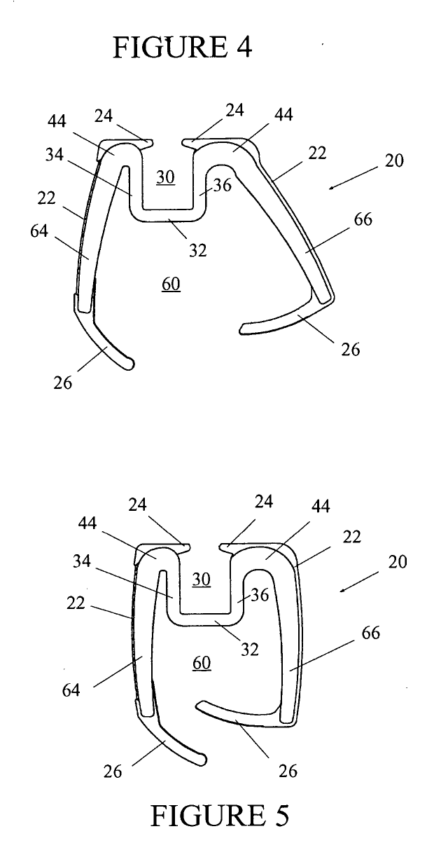

Manufacture of the division bar assembly 20 includes at least a two-step process. Initially, the division bar assembly 20 is formed as a division bar body, such as by extrusion, in a splayed, or open configuration, as shown in FIGS. 4, 6, 8, 10 and 12. By being formed (extruded) in an open or splayed configuration, the closed end 32, the pocket legs 34, 36, the channel legs 64, 66, the sealing lips 24, 26 and any overlay layer 22 can be generally coextruded, wherein the die has sufficient structure to maintain the integrity of the die opening and increase useful life of the die.

After formation (extrusion) of the division bar assembly 20, and any associated locator lips 24, sealing lips 26 and overlay layer 22, in the open position, and typically before the materials acquire their final rigidity, the division bar assembly is post-formed (or shaped) into the final cross section, such as in FIGS. 2, 3, 5, 7, 9, 11 and 13. The post-forming can include rotation of the channel legs 62, 64 from the splayed position to a generally parallel position. A sizing bar can be employed downstream of the extrusion die to shape the extrusion to the desired cross sectional profile. Typically, the post-forming usually occurs within 10 feet of the extrusion die and preferably within 5 feet, and more preferably within 2 feet of the extrusion die. The post-forming has been found satisfactory when performed during the phase transition of the (extruded) material from a molten phase to a solid phase. That is, as the (extruded) material is between a fully molten state and a fully solidified state, the division bar assembly 20 is post-formed.

As seen in FIGS. 4-11, both the channel legs 62, 64 can be moved from a splayed position to the shaped (post-formed) position. It is also understood, as seen in FIGS. 12 and 13, that one of the channel legs 64 can be formed (such as by extrusion) in the splayed position and post-formed to the finished position, such as in FIG. 13, while the channel leg 64 is formed (extruded) in a finished position and thus is not post-formed.

The realignment of the channel legs 64, 66 from the splayed position to the finished position can be accomplished by a rotation of the channel legs at the transition 44, or a slight deformation at the junction of the channel legs and the pocket legs. Typically, the realignment of the channel legs 64, 66 relative to the pocket 30 will occur at the transition 44. However, the material may be sufficiently molten to allow the reconfiguring of the post-forming to be distributed through the formed body, thus shape change is not concentrated in any particular area of the division bar assembly 20.

The division bar assembly 20 allows forming (extrusion) in the splayed configuration and the downstream post-forming (shaping) to the operable, closed, position without imparting witness marks or lines The transition 44 between the pocket legs 34, 36 and the channel legs 64, 66 is typically selected to allow the post-forming or bending without imparting such witness lines to the division bar assembly 20. In addition, formation of the division bar assembly 20 in the splayed configuration allows the extrusion of the locator lips 24 and the sealing lips 26 of different material than the pocket 30 and the channel 60.

It is also contemplated the division bar assembly 20 can be formed in a molding process, wherein the post-forming shapes the assembly to a relatively closed position.

The present configuration also provides for a reduced angle of closure for the channel legs 64, 66 between the formed position and the post-formed position. That is, by locating the transition 44 between the channel legs 64, 66 and the pocket legs 34, 36 at or adjacent the free end of the channel legs, the angular displacement between the channel legs in the formed position and the post-formed position decreases. For the extrusion die to form the sealing lips 26 between the channel legs 64, 66 the free ends of the channel legs must be relatively widely spaced apart. To move the free ends of the channel legs 64, 66 to the finished orientation, the legs can be rotated about the transition 44. As the sealing lips 26 are spaced from the transition 44 by substantially the entire length of the channel legs 64, 66, the angular displacement of the channel legs between the formed position and the post-formed position is minimized. Thus, the division bar assembly 20 can minimize the amount of required post-forming by maximizing the length of the channel legs 64, 66 thereby reducing any associated witness line.

It is contemplated the sealing lips 26 can have a length such that terminal ends of the sealing lips overlap within the channel 60 after the post-forming step, yet the terminal ends of the sealing lips are laterally spaced apart in the forming step. That is, the channel legs 64, 66 can be formed in a sufficiently splayed position that the entire length of each sealing lip 26 is located between the splayed legs, without the sealing lips overlapping. For example, the distance between the formed, splayed channel legs 64, 66 is greater than the combined length of the sealing lips 26. The post-forming can then decrease the distance between the channel legs 64, 66 to be less than the combined length of the sealing lips 26. This allows the manufacture of a relatively complex division bar assembly 20 by means of a relatively simple die construction.

As seen in FIGS. 2-5, the outer surface of the channel legs 64, 66 provide a continuous and finished exposed surface of the division bar assembly 20 to the exterior and interior of the vehicle, respectively.

The division bar assembly 20 is formed without structural metal, such as a traditional rolled formed metal. The materials of the pocket 30 and the channel 60 are selected to provide sufficient rigidity to perform the required functions without requiring structural metal.

However, it is understood the division bar assembly 20 can include metal in the form of a filler, trace amounts or colorants, and particularly those amounts that do not inhibit subsequent recycling of the polymer material. Such metal is in contrast to the structural metal sufficient to reinforce the pocket 30 or the channel 60.

It is also understood the division bar assembly 20 can include a longitudinally extending wire, or wires, to provide length control during the manufacturing process. Such wire does not materially or significantly increase resistance of the division bar assembly 20 to transverse or lateral bending or torsion and is thus not a structural metal. That is, such wire provides control in only a single dimension (longitudinal) and does not otherwise strengthen the division bar assembly 20.

The absence of such structural metal allows the division bar assembly 20 to be lighter weight than prior division bars. Further, as the materials for the division bar assembly 20 can be thermoplastic, the entire assembly is readily recyclable. The materials can also be selected to provide color matching to an adjacent portion of the vehicle. That is, the availability of the overlay layer 22 allows the division bar assembly 20 to assume any of a wide variety of colors.

In addition, as the division bar assembly 20 is formed in the open configuration, the associated extrusion die is more robust and easier to manufacture than dies for forming the prior configurations.

Further, as the only modification is a post-forming (or reshaping) from the open position to the closed position, the number of manufacturing steps or processes is reduced.

While a preferred embodiment of the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

1. A method of forming a vehicular division bar assembly for receiving a fixed pane and a moveable pane, the method comprising:
(a) forming a division bar body free of structural metal, the division bar body having (i) a U-shape pocket for receiving the fixed pane, the pocket defined by a pocket closed end and a pair of projecting pocket legs, and (ii) a channel for receiving the moveable pane, the channel at least partially defined by the pocket closed end and a pair of channel legs, at least one channel leg extending from one pocket leg to dispose the pocket closed end between the channel legs, and the channel legs in a diverging orientation; and
(b) post-forming at least one channel leg to dispose the channel legs to a less diverging orientation.

2. The method of claim 1, further comprising forming a sealing lip to extend from one of the channel legs into the channel.

3. The method of claim 2, further comprising forming the division bar body of a thermoplastic and the sealing lip of a thermoplastic elastomer.

4. The method of claim 1, further comprising post-forming the channel legs to a substantially parallel orientation.

5. The method of claim 1, further comprising forming the division bar body of a thermoplastic.

6. The method of claim 1, further comprising forming the division bar body of a thermoplastic elastomer.

7. The method of claim 1, wherein forming the division bar body includes extruding the division bar body.

8. The method of claim 1, further comprising forming the channel legs longer than the pocket legs.

9. The method of claim 1, further comprising forming the pocket legs of substantially equal length.

10. The method of claim 1, further comprising connecting each channel leg to the pocket leg at a terminal end of the pocket leg.

11. The method of claim 1, further comprising disposing an entire length of the pocket legs intermediate the channel legs.

12. The method of claim 1, wherein post-forming the at least one channel leg includes shaping the channel leg.

13. The method of claim 1, further comprising cooling the division bar body and heating the division bar body prior to post-forming the at least one channel leg.

14. A division bar assembly formed by the method of claim 1.

15. A vehicular division bar assembly for receiving a fixed pane and a moveable pane, the division bar assembly comprising:
(a) a U-shape pocket receiving the fixed pane, the pocket defined by a pocket closed end and a pair of pocket legs; and
(b) a channel receiving the moveable pane, the channel at least partially defined by the pocket closed end and a pair of channel legs, at least one of the channel legs connected to one of the pocket legs at a position spaced from the pocket closed end, the channel and the pocket being free of structural metal.

16. The vehicular division bar assembly of claim 15, wherein the connection of the channel leg and the pocket leg to locate the closed end intermediate terminal ends of the channel leg.

17. The vehicular division bar assembly of claim 15, wherein each channel leg is connected to a pocket leg to dispose the pocket closed end intermediate the channel legs.

18. The vehicular division bar assembly of claim 15, further comprising a sealing lip connected to one of the channel legs and extending into the channel.

19. The vehicular division bar assembly of claim 15, wherein each channel leg is connected to the pocket leg at a terminal end of the pocket leg.

20. The vehicular division bar assembly of claim 15, wherein the channel legs are longer than the pocket legs.

21. The vehicular division bar assembly of claim 15, wherein an entire length of the pocket legs is disposed intermediate the channel legs.

22. The vehicular division bar assembly of claim 15, wherein the channel legs are selected to define an exposed lateral surface of the division bar assembly.

23. The vehicular division bar assembly of claim 15, wherein the channel legs overlie the pocket legs.

24. The vehicular division bar assembly of claim 15, wherein the pocket and the channel legs are integral.

25. The vehicular division bar assembly of claim 15, wherein the pocket and the channel legs are thermoplastic.

26. The vehicular division bar assembly of claim 15, wherein the pocket and the channel legs include a thermoplastic elastomer.

27. The vehicular division bar assembly of claim 15, wherein the pocket and the channel legs are formed of a single durometer material.
